(19) United States
(12) Patent Application Publication
(10) Pub. No.: US 2007/0176748 A1
(43) Pub. Date: Aug. 2, 2007

(54) Method and Device for Radiofrequency Communication

(75) Inventor: Phillipe Francois Salamitou, Versailles (FR)

Correspondence Address: THE JANSSON FIRM, 9501 N. CAPITAL OF TX HWY #202, AUSTIN, TX, 78759, US

(73) Assignee: SRETT, Paris (FR)

(21) Appl. No.: 11/617,354

(22) Filed: Dec. 28, 2006

(30) Foreign Application Priority Data
Dec. 29, 2005 (FR) 0554140

(51) Int. Cl. H04Q 5/22

(52) U.S. Cl. 340/10.1; 340/10.33; 340/10.5

(57) ABSTRACT

The invention concerns a method and a device for radiofrequency (RF) communication. According to the method, a communication can be set up between a reader (12) and an RF device (10) at least over a medium distance and over a short distance. The short distance communication is set up using an RF-ID transponder (20) and an antenna (16).

In order to set up the medium distance communication, the reader (12) sends a command signal to the RF-ID transponder (20) in order to power up at least one microcontroller (24) and a transceiver (34). The microcontroller (24) sends to the reader (12), via the transceiver (34), a reply message comprising at least the identification of the device (10).

### FIELD OF THE INVENTION

This invention relates to a method and a device for radiofrequency (RF) communication operating for example in the ultra-high frequency (UHF) range, i.e. from 300 to 3000 MHz.

### BACKGROUND OF THE INVENTION

RF devices are generally associated with equipment or products for various applications, such as identification of products or equipment, logistics, quality control, monitoring and preventive maintenance. In simple terms, an RF device is part of a communication network which includes a reader managing communication by radio waves with a number of RF devices and a terminal or server composed of at least a computer connected by wired or wireless link to the reader. The terminal communicates with the reader and saves and processes data exchanged between the reader and the RF devices.

The structure and operation of the RF devices are optimized for each application. Therefore, these devices are generally neither identical nor compatible with each other.

There are several families of RF devices classified according to their range, i.e. the distance separating the reader from the RF devices for which a communication may be set up:
RF-ID (Radio Frequency Identification) tags. These are UHF devices operating according to the passive transponder principle. They include an antenna and an elementary electronic circuit (the transponder as such) contained on a simple chip. They include no active UHF circuits and do not necessarily have an energy source such as a battery. In the latter case, the electrical energy is supplied to the RF-ID tag by the electromagnetic wave sent by the reader. For reception, the RF-ID tag detects the presence of a signal sent by the reader and reads the amplitude modulation of the signal received. For transmission, the RF-ID tag reflects to the reader the UHF signal received, modulating it in amplitude or phase (for example by modulating the antenna impedance). An RF-ID tag consumes very little energy and can be used to communicate the identification code of the product with which it is associated quickly but over a short distance (typically a few meters).
personal RF networks (often known as Wireless Personal Area Networks—WPANs). They can be used to transmit various types of data quickly, over medium distances (typically a few tens of meters). These systems include RF devices associated with products or equipment which communicate with a reader. Each RF device traditionally includes an antenna, a transceiver (transmitter/receiver, much more complex than a transponder), a microcontroller or microprocessor, a memory, a power supply source and various inputs and outputs. Such devices are used for example to communicate quickly and temporarily without the need to set up a wired link. These devices are generally powered by a rechargeable battery.
permanent wireless communication systems with very low consumption and high range (up to several kilometers). They are used in particular for remote monitoring of equipment operation. These systems include RF devices associated with the equipment, whose hardware architecture is similar to that of the devices used for the personal RF networks, but whose software architecture and communication protocols are different. These devices are characterized by their very low electrical consumption and the high latency in setting up a new communication. These devices generally include a sensor and its associated electronics and/or a data memory. They are used to transmit recurrent data slowly, over a long distance. They are used, for example, for remote reading of water, gas and electricity meters. They are generally powered by a non-rechargeable battery.

In the remainder of this document, short, medium and long distance (or range) will be taken to mean a distance of respectively up to a few meters (for RF-ID passive transponders), a few tens of meters (for personal RF networks) and several hundred meters. These three distances are only orders of magnitude which correspond to the three technology families indicated previously.

The RF devices of different ranges are not compatible with each other because they use different architectures, optimized to meet the specific requirements of each type of device. The short range RF devices use passive RF-ID transponders with very low consumption (the order of the microwatt) and the medium and long range devices use active transceivers, capable of generating signals at the frequency of the radiofrequency carrier, but consuming more energy (typically of the order of several tens of milliwatts in transmission or reception).

However, it may sometimes be desirable to combine the features of several types of RF device on the same product or item of equipment. For example, a gas meter with a long range RF device for remote reading of the quantity of gas consumed could advantageously benefit during its manufacture and shipment from the features of a short range passive RF-ID tag. It could also benefit from the features of a medium range fast link in order to update its embedded software.

However, the association of several independent RF devices on a given product is not recommended for cost, size and operating quality considerations.

The patent application WO 2004/023389 A2 published on 18 Mar. 2004 describes an RF device used to communicate over a short distance, less than 2 feet (1 m) and over a long distance, less than 500 feet (160 m). For the long range communication, it comprises a transceiver connected to an antenna enabling a reader to read the device identification code and, for the short range communication, an interface connected to another reader by secured link in order to send confidential information. When the short distance communication takes place via radio wave, the interface is a transceiver similar to that used for the long range link, but of lower range.

The patent application WO 2005/091997 A2, published on 6 Oct. 2005, describes the use of technologies specific to the RFID systems to set up a medium range communication (especially of type “Bluetooth”) between two mobile telephones more quickly. In this patent application, the two telephones may in turn play the role of reader (or master) and RF-ID transponder (or slave). They each comprise Bluetooth communication means and a passive or active RF-ID transponder. An RF-ID type query signal is sent by the reader terminal. The transponder of the slave terminal replies by sending the address of its Bluetooth communication module and informs a control module of the slave terminal of the Bluetooth communication request. The control module determines whether or not the communication is acceptable (e.g. the user of the slave terminal may have deactivated the Bluetooth function). If the communication is acceptable, the Bluetooth module of the slave terminal switches into listen mode. The reader terminal starts to communicate with the Bluetooth communication module of the slave terminal. Any long range communications are carried out using traditional mobile telephony means, e.g. GSM technology. Bluetooth and GSM technologies require relatively high electric currents in order to operate. It is well-known that mobile telephones contain batteries which the user must recharge regularly, at least after several days, depending on the use and location of the telephone.

### SUMMARY OF THE INVENTION

This invention proposes a method and an RF device capable of operating over at least short distances (operating as RF-ID tag) and medium distances. According to a preferred mode of realization, the device is also capable of operating over long range. For these three operating modes, the device consumes very little electric current. Consequently, the lifetime of the power source for the device circuits (preferably a battery), and therefore the lifetime of the device when the battery is not rechargeable or cannot be changed, may be very long (for example about ten years). In addition, the device is relatively cheap compared with the sum of the costs of a short range device, a medium range device and a long range device.

To obtain high autonomy (e.g. 10 years), the device according to the invention is “asleep” most of the time in a passive operation mode with very low energy consumption. In other words, the device is only activated when it is requested to communicate with a query device or reader, then switching from “asleep” or passive mode to active mode for which the various elements of the device may operate, e.g. process signals. The transition from passive to active state can be carried out by powering up (connection to an electrical power supply) one or more components of the device.

For short and medium range communications, the device is woken up by an RF-ID query signal transmitted by the reader and picked up by an antenna of the device, thereby creating sufficient electrical voltage to wake up the device. For short range communications, an RF-ID transponder is sufficient to operate the device and, consequently, there is no need to use energy other than that from the RF-ID signal of the reader. For medium range communications, an RF-ID signal picked up by an RF-ID transponder of the device wakes up at least one microcontroller, advantageously by powering it up. For long range operation, an internal clock wakes up the device at periodic programmed time intervals.

More precisely, the invention relates to an RF communication method according to which a communication can be set up between a reader and an RF device at least over a medium distance and over a short distance, the short distance communication being set up using an RF-ID transponder and an antenna. According to the invention, in order to set up the medium distance communication, the reader sends a command signal to the RF-ID transponder in order to switch at least one microcontroller and a transceiver from a passive state to an active state, the microcontroller sending to the reader, via the transceiver, a reply message comprising at least the device identification.

The reply message may also comprise data to synchronize the reader and the device.

Preferably, the method can also be used for long distance communication, a clock signal waking up the microcontroller, which then communicates with a reader via the transceiver.

Advantageously, the microcontroller checks whether the device is already in short or medium distance operation and, if this is the case, it decides to set up the communication in long range operation at a later time, which can be determined randomly.

Preferably, the duration of each message of the long distance communication is chosen to be much less than the duration of a short distance communication. A long distance communication can be divided into several transmission-reception messages and between two successive messages, the microcontroller checks that the reader is not transmitting any query signals in RF-ID mode.

Advantageously, the medium and long distance communication uses the same antenna as for the short distance communication.

According to one mode of realization, the microcontroller commands the switchover of a switch between a short distance communication position for which the antenna is connected to the RF-ID transponder and disconnected from the transceiver and a medium and long distance communication position for which the antenna is connected to the transceiver and disconnected from the transponder.

At the end of each communication with the reader, the switch is systematically returned to the short distance communication position.

According to another mode of realization, the medium and long distance communication uses a frequency range different from that of the short distance communication. The antenna is designed to operate in both frequency ranges. A frequency selective coupler simultaneously connects the transceiver to the antenna in one frequency range and the RF-ID transponder to the antenna in another frequency range.

Advantageously, at the end of each communication with the reader, the device is no longer powered electrically apart from the clock.

The invention also relates to a radiofrequency RF communication device with a reader, the device being able to communicate at least over a short distance and over a medium distance and comprising an antenna and an RF-ID transponder connected to the antenna. According to the invention, the device also includes a programmed microcontroller, a transceiver connected to the microcontroller and an electrical power source, the short distance communication being carried out using the antenna and the transponder. The transponder detects, in a message sent by the reader, the presence of a wake-up command and connects at least the microcontroller to the electrical power source when the wake-up command is detected. The medium distance communication can then take place via the microcontroller and the transceiver.

According to one mode of realization, the means to connect the microcontroller to the electrical power source comprise a relay connecting the microcontroller to the electrical power source, the open or closed position of the relay being commanded by the transponder.

Advantageously, the device can also be used for long distance communication and, accordingly, it includes a clock to periodically wake up the microcontroller and the transceiver which are required for the long distance communication.

According to another mode of realization, the device includes a switch connected to the antenna, the transceiver and the transponder being connected in parallel with the switch which can take two positions, a short distance communication position for which the antenna is connected to the transponder and a medium or long range communication position for which the antenna is connected to the transceiver.

The device includes means to systematically return the switch to the short distance communication position after each medium or long range communication.

According to another mode of realization, the device includes a frequency selective coupler used to simultaneously connect the antenna and the transceiver in a first frequency range, and the antenna and the transponder in a second frequency range.

Preferably, the device includes means to systematically disconnect the microcontroller from the electrical power source after each medium or long distance communication.

The microcontroller may be a microprocessor or an electronic circuit as wired logic.

The communications between the reader and the device are set up in a frequency band, in particular the UHF frequencies between 300 MHz and 3000 MHz, preferably in one of the frequency bands [300 and 450 MHz], [860 and 930 MHz] and [2400 to 2600 MHz].

### BRIEF DESCRIPTION OF THE DRAWINGS

Other features and advantages of the invention will appear on reading the following description, given purely as an example and referring to the attached drawings, on which:

FIG. 1 is a diagrammatic representation of a preferred mode of realization of the invention; and

FIGS. 2 to 5 illustrate various modes of utilization of the invention.

### DETAILED DESCRIPTION

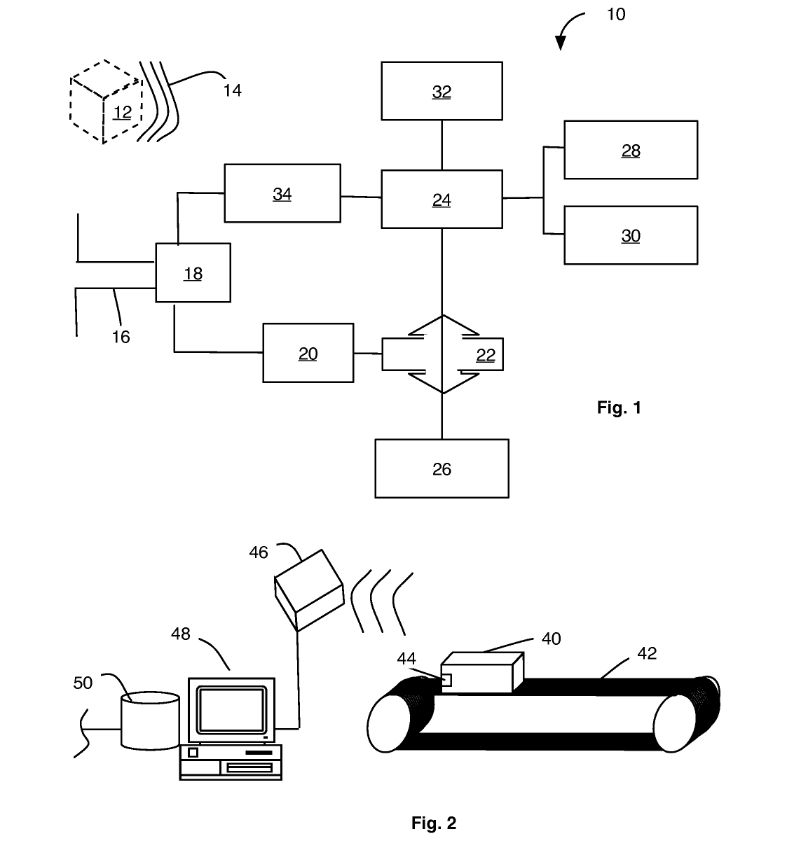

The RF device 10 represented diagrammatically on FIG. 1 is capable of communicating with a reader device 12 by radio waves 14. The reader device 12 may query the RF device 10, which sends a reply message in response to a query. The radio waves 14 carry reply messages intended for the RF device 10. In the remainder of this document, the reader device 12 is simply referred to as “reader”. The reader 12 manages the communication with the RF device 10. The reader 12 is generally part of a communication network and is connected by wired or wireless link to a terminal for acquisition and processing of data from the RF device 10, the data being collected using the reader 12. The terminal may be a simple computer, a server or a more complex system which may traditionally include one or more additional computers, one or more memories, one or more databases, etc. The RF device 10 is intended to be associated with an object, for example by being attached to said object. In practice, the reader 12, which may be fixed or portable, generally communicates with a number of identical devices 10, although in principle one reader may be dedicated to a single RF device.

The device 10 includes an antenna 16 allowing radio communication with the reader 12. The type and geometry of the antenna 16 are chosen according to the frequency bands used for communication with the reader. Various types of antenna are available, for example single or multiple, active or passive. The antenna is adapted to operate advantageously in UHF (from 300 MHz to 3000 MHz), but preferably in the frequency bands generally authorized for this type of device [300 and 450 MHz], [860 and 930 MHz] and [2400 to 2600 MHz]. The frequencies around (and including) 900 MHz are nevertheless preferred for the performance they offer in terms of electricity consumption, transmission speed and communication range.

The antenna 16 is connected by a switch 18 to an RF-ID transponder 20 manufactured traditionally in the form of an electronic chip. The transponder 20 may be passive type, and in this case it draws its energy to operate from the RF-ID signal which it receives from the reader 12, or semi-passive type if the energy supplied by the RF-ID signal is not sufficient for the transponder to operate. It is then connected to an electrical energy source (to the battery 26 for the mode of realization shown on FIG. 1). Since the transponder does not include any active UHF elements, its electrical energy consumption is very low (of the order of the microwatt).

The RF-ID transponder 20 is arranged to detect a wake-up signal sent by the reader. The wake-up signal commands the electrical power supply of the device 10. The wake-up signal may be in the form of an RF signal of a particular frequency and whose amplitude exceeds a given sensitivity threshold. For example, the wake-up signal may correspond to an occurrence of the radio waves 14 illustrated in FIG. 1. Alternatively, the wake-up signal may be in the form of a specific message, which is carried by the radio waves 14. In that case, the RF-ID transponder may comprise, for example, a basic microcontroller that is programmed to analyze messages carried by the radio waves 14 and, in doing so, to detect a wake-up message among these messages. As another example, the RF-ID transponder may comprise wired logic that screens incoming messages and that provides a “true” output when a wake-up message is present therein.

On reception of the wake-up message, the transponder 20 commands a relay 22 which connects a programmed microcontroller 24 with an electrical power source 26, preferably consisting of a long duration electrical battery, generally (but not necessarily) non rechargeable. The relay is a simple electronic relay. The microcontroller 24 may be a microprocessor or produced using wired logic. A program containing a series of instructions is loaded in a memory of the microcontroller or in a related memory 28 connected to the microcontroller. In both cases, the memory is large enough to save the data required to perform the various functions of the device 10. A sensor 30 (e.g. a thermometer, pressure or vibration sensor) and its associated electronics may be connected to the microcontroller 24.

A clock 32 is connected to the microcontroller 24. This clock has low power consumption and the signals it transmits are capable of performing the programmed “wake-up” of the microcontroller 24.

An active RF transceiver (transmitter/receiver) 34 is connected firstly to the microcontroller 24 and secondly to the switch 18, which is connected to the antenna 16. It operates at the same frequency as the RF-ID transponder 20 and therefore preferably at about 900 MHz. Since it includes active heterodyne UHF components, it must be connected to the electrical energy source 26 to operate. This connection is set up by the microcontroller 24 which commands the connection or disconnection of the transceiver 34.

In idle state, the electrical battery 26 is not connected to any components of the device 10, apart from the clock 32 and possibly the transponder 20 if it is semi-active type, since the clock only requires an extremely low current to operate.

In short and medium range operation, the reader 12 sends to the device 10 an electromagnetic signal of type RF-ID. This signal is picked up by the antenna 16, and then directed by the switch 18 to the transponder 20. The RF-ID signal supplies sufficient energy to operate the transponder 20. There may be two cases.

According to a first case, which concerns short range operation, the RF-ID signal simply comprises a request for the identification code of the transponder 20; the transponder wakes up and replies by sending its identification code to the reader 12. The RF-ID signal may also be encoded, in which case the transponder 20 decodes the signal and only replies to the reader if it validates the code. The communication may continue between the reader and the transponder 20 according to an RF transponder communication standard. The transponder 20 may simply be of passive type.

According to a second case which concerns medium range operation, the RF-ID electromagnetic signal transmitted by the reader wakes up the transponder 20. This signal comprises a wake-up command to switch the relay 22 in order to connect the microcontroller 24 to the battery 26. The transponder 20 then executes the wake-up command. The RF-ID signal may also be encoded and in this case the transponder decrypts the signal and only switches the relay 22 if the code is validated. The microcontroller 24 then executes the program loaded in its internal memory or in the memory 28. It starts by commanding the powering up of the transceiver 34 and possibly of the memory 28 and of the sensor 30 and of its associated electronics, then the positioning of the switch 18 to connect the transceiver 34 to the antenna 16. The microcontroller 24 then sends to the reader 12 the identification code of the device 10, which may be identical to that of the transponder 20, via the transceiver 34, the switch 18 and the antenna 16. The reply from the microcontroller may also be more complete and include, for example, data concerning its internal clock in order to synchronize the reader 12 and the device 10. The latter is then listening to the reader 12 and a medium distance communication can be set up. According to another mode of operation, the transponder 20 may reply to the reader directly, sending its identification code and then connect the battery 26 to the microcontroller 24, which then starts execution of its program as previously apart from sending its identification since this has already been carried out. At the end of the medium range communication, the microcontroller 24 systematically commands the switchover of the switch 18 in order to connect the antenna 16 to the transponder 34, then the positioning of the relay 22 in order to switch off the electrical power supply of the device 10, apart from the clock 32.

In long range operation, the clock 32 sends a wake-up signal to the microcontroller 24, which is then connected to the battery 26 and to the transceiver 34, the memory 28 and possibly the sensor 30. The microcontroller then executes its program enabling it to start a long range communication via the transceiver 34, the switch 18 and the antenna 16. The switch 18 is therefore positioned so as to connect the transceiver 34 to the antenna 16.

However, in order to avoid a collision between two different types of communication and to guarantee the availability of the device in RF-ID mode, the microcontroller gives priority to short distance communications (in RF-ID transponder operation), then to medium range communications. To do that, it first checks that there have been no reads by the medium range mode for a certain length of time, for example about one minute. The microcontroller then checks, for example using the receiver function of the transceiver, that no reader is trying to query it by a transponder mode. If these two conditions are not met, it cancels the long range communication request and reprograms the clock 32 to send a new wake-up signal at a time chosen preferably randomly, for example by random sampling according to the ALOHA protocol. In addition, the aim is to avoid the possibility of a long range communication already set up preventing RFID query by the short range communication mode. Consequently, the duration of a long range communication message must be very short compared with the duration of an RF-ID query by a reader. Advantageously, the long range communication is divided into short messages and after sending each short message, the microcontroller checks that no RF-ID query signal has been sent by a reader. For example, it could be decided that a transmission and reception must not last longer than 50 ms. After each 50 ms period, the microcontroller listens to check that it is not receiving an RF-ID query signal from a reader. If this condition is met, it continues the long range communication. If this condition is not met, it interrupts the long range communication and reprograms the clock 32 to send a new wake-up signal which will enable it to resume the interrupted communication.

As with the medium range communications, at the end of each long range communication, the switch 18 is systematically positioned to connect the transponder 20 with the antenna 16 and the relay 22 is switched in order to switch off the power supply of the device 10, apart from the clock 32. The device 10 is then asleep.

The short, medium and long range communications between the reader and the device 10 may use common communication protocol layers, the physical layer of the protocol (i.e. the layer concerning transmission and reception of data bits via the communication interface) must however be different depending on whether the communication is short, medium or long range.

For the short range communications, it is advantageous to use a standard protocol, for example the EPC Class 1 generation 2 or ISO 18000-6c protocol, these two standardized protocols being equivalent. The communication frequency is in the band 860 to 960 MHz and ASK type modulation is used for the RF signals for communication from the reader to the RF device, with a bit rate of 26.7 kbps to 128 kbps, and ASK or PSK type modulation is used for communication from the RF device to the reader, with a bit rate of 40 kbps to 640 kbps (kbps=kilobits per second). For example, the EPC class 1, generation 2 protocol can read from 600 to 1600 RF devices in RF-ID transponder mode, with a range varying from 6.6 to 7 meters for the read operations.

Advantageously, the medium range communication protocol may use the MAC (Media Access Control) layer and the logic layer of the protocol used for the short range communication.

The long range communications may use a communication protocol with very low consumption, as defined by the IEEE 802.15.4 standard and the Zigbee standard.

Only one reader 12 has been represented on FIG. 1, but obviously a different reader can be used for each type of communication range (short, medium or long range). Several equivalent readers 12 can operate simultaneously in the RF coverage zone of the same device 10. Communication conflicts are generally managed by the communication protocols used and the software associated with the terminals and the communication network.

According to another mode of realization of the invention, the switch 18 is replaced by a frequency selective coupler. The medium and long distance communication then uses a frequency range different from that used for the short distance communication. The same antenna, designed to operate in both frequency ranges, is used for the short, medium and long distance communications. The frequency selective coupler simultaneously connects the transceiver 34 to the antenna 16 in one frequency range and the RF-ID transponder 20 to the antenna 16 in another frequency range.

FIGS. 2 to 5 illustrate different applications of the invention, an RF device identical to device 10 on FIG. 1 being fixed to a product, an article or item of equipment. An RF device could also be attached to a package or container containing several products, to provide data not only on the products themselves but also on the package or the container.

On FIG. 2, products represented symbolically by one of them, product 40, are being manufactured or converted or reconditioned and move on a conveyor belt 42. An RF device 44 identical to the device 10 shown on FIG. 1 is attached to each product 40. An RF reader 46 is positioned near the products in order to set up a short and medium range communication. The reader is connected by wired link to a station comprising a computer 48 and a database 50. The latter form, with the reader 46 and the devices 44, a communication network.

The reader transmits an RF-ID query signal which wakes up the devices 44. The latter reply by transmitting their identities. Via the short distance link, the reader selects amongst the devices 44 which have replied, those with which it wants to set up a medium distance communication. The special medium distance communications it sets up can be used to exchange information between the reader and the memories of the RF devices, such as for example information concerning the product type, destination and/or use, or information concerning the calibration parameters associated with the sensor included in the device 44. The information exchanged may come from the database 50 or be transmitted to this database.

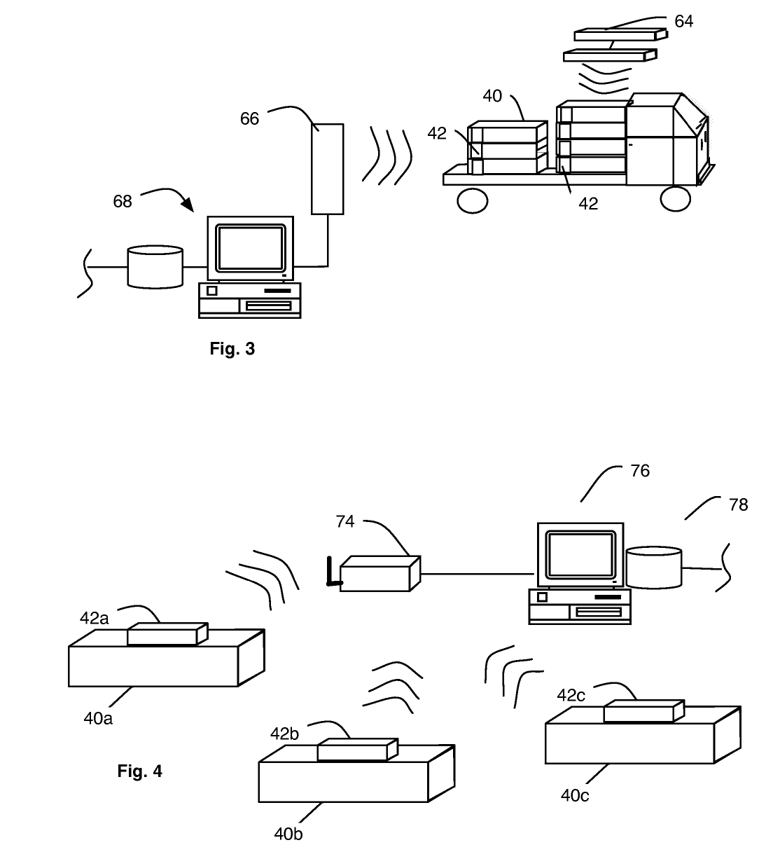

FIG. 3 illustrates the implementation of the invention for an automated inventory of the products 40. This method can be used to quickly take an inventory of the products equipped with an RF device located within the coverage field of a suitable reader. This method is similar to the traditional use of an RF-ID tag.

The products 40 equipped with RF devices 42 are handled near two suitable readers 64 and 66. The latter wake up the RF devices 42, which communicate their identification codes. These identification codes are compared with the data of the communication infrastructure 68 which, as previously, consists mainly of a computer and a database. The reader 64 communicates with the infrastructure 68 by radio, for example using a WiFi connection, whereas the reader 66 is connected by wired link to the infrastructure 68.

The communication protocol between the RF devices and the readers may be a standardized protocol. As a result, standard readers can be used.

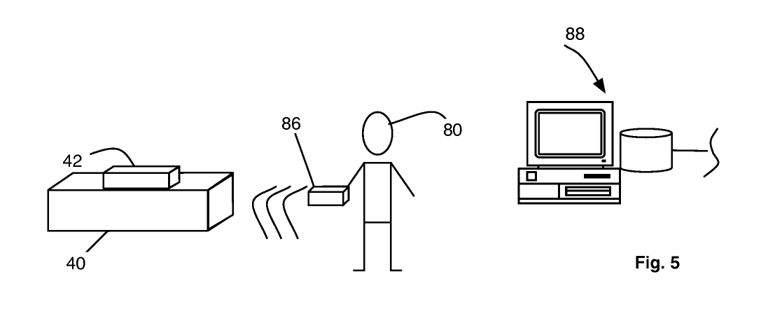

The RF devices illustrated on FIG. 4 are used to monitor the presence and state of three of the products 40, throughout the lifetime of these products, referenced 40a, 40b and 40c, and on which the RF devices 42, referenced 42a, 42b and 42c are attached. On FIG. 4, the three products are in three different locations. The RF device 42 wakes up periodically to start a long range communication with a reader 74 present in the RF communication coverage zone. The reader 74 is connected, as previously, to an information infrastructure consisting of a computer 76 which is connected to a database 78. On activating the long range communication, the products 40a, 40b and 40c near the reader 74 are located. The information exchanged during this communication may include in particular the product identification codes, an alarm, the measurements obtained by a sensor associated with the devices 42a, 42b and 42c and the time remaining before the use-by-date of each product. The communication periods may vary, to adapt to special circumstances, for example if a problem is detected on a particular product.

The operating mode illustrated on FIG. 5 enables an operator 80 to exchange information at medium distance with an RF device 42 attached to one of the products 40. The operator 80, equipped with a portable reader 86, wakes up the device 42 using a short range communication. It sets up a medium range communication. This communication enables it to exchange information with the memory of the RF device 42. If several RF devices are within the RF coverage zone of the reader 86, the operator can use their identification codes or the power of the signal received to distinguish between them. The RF device 42 can also simplify its identification by emitting an audible or visible signal. The portable reader 86 can be connected permanently or temporarily to an information infrastructure 88, by a wired or wireless link.

RF devices according to the invention can also be used in relation with human beings or animals. They can be used, for example, to monitor sick or convalescent people, whether in hospital or at home. Information concerning a patient is stored in the memory of an RF device according to the invention. One or more sensors associated with this device can be used to monitor particular parameters of the patient. Short range operation can be used to record the patient's transfers from one location to another. The long range communication mode by programmed wake-up using an internal clock can be used to transmit the data acquired by the sensor(s) and possibly an alarm. The medium range communications can be used to access the patient's information and the history of the data acquired by the sensor(s).

Modes of realization other than those described and represented can be designed by those skilled in the art, without leaving the scope of this invention.

1. A radiofrequency (RF) communication method according to which a communication can be set up between a reader and an RF device at least over a medium distance and over a short distance, the short distance communication being set up using an RF-ID transponder and an antenna, the medium distance communication being set up by the reader sending a command signal to the RF-ID transponder in order to switch at least one microcontroller and a transceiver from a passive state to an active state, said microcontroller sending to the reader, via said transceiver, a reply message comprising at least the identification of the RF device.

2. The method according to claim 1, said reply message also comprising data for synchronizing the medium distance communication of said reader with the RF device.

3. The method according to claim 1, which also involves a long distance communication, in which a wake-up signal transmitted by a clock wakes up said microcontroller, which then communicates with said reader via said transceiver.

4. The method according to claim 3, in which, after having received said wake-up clock signal, said microcontroller checks whether the RF device is already in short or medium distance operation and, if this is the case, said microcontroller decides to set up the long range operation communication at a later time.

5. The method according to claim 3, in which a long distance communication is divided into several transmission-reception messages and in which, between two successive messages, said microcontroller checks that said reader is not transmitting any query signals in RF-ID mode.

6. The method according to claim 1, in which, at the end of each communication with said reader, the RF device is no longer electrically powered apart from a clock.

7. A device for radiofrequency (RF) communication with a reader, the device being able to communicate at least over a short distance and over a medium distance and comprising an antenna and an RF-ID transponder connected to said antenna, the device also including a programmed microcontroller, a transceiver connected to said microcontroller and an electrical power source, the short distance communication being carried out using said antenna and said RF-ID transponder said RF-ID transponder being arranged to detect a command signal sent by said reader and to connect at least said microcontroller to said power supply source when said command signal is detected, so that the medium distance communication can take place via said microcontroller and said transceiver.

8. The device according to claim 7, the device including a switch coupled to, on the one hand, said antenna and, on the other hand, to said transceiver and to said RF-ID transponder, said switch being able to take two positions, a short distance communication position for which the antenna is coupled to said RF-ID transponder and a medium or long range communication position for which the antenna is coupled to the transceiver.

9. The device according to claim 7, the device including a frequency selective coupler capable of connecting simultaneously the antenna to the RF-ID transponder and to the transceiver, in two separate frequency ranges.

10. The device according to claim 7, the device including at least one sensor connected to said microcontroller.

11. A radiofrequency (RF) communication method according to which a communication can be set up between a reader and an RF device at least over a medium distance and over a short distance, comprising:
using an RF-ID transponder and an antenna to set up the short distance communication;
sending a command signal from the reader to the RF-ID transponder the medium distance communication being set up by the reader sending a command signal to the RF-ID transponder in order to switch at least one microcontroller and a transceiver from a passive state to an active state, said microcontroller sending to the reader, via said transceiver, a reply message comprising at least the identification of the RF device.

12. The method according to claim 11, said reply message also comprising data for synchronizing the medium distance communication of said reader with the RF device.

13. The method according to claim 11, which also involves a long distance communication, in which a wake-up signal transmitted by a clock wakes up said microcontroller, which then communicates with said reader via said transceiver.

14. The method according to claim 13, in which, after having received said wake-up clock signal, said microcontroller checks whether the RF device is already in short or medium distance operation and, if this is the case, said microcontroller decides to set up the long range operation communication at a later time.

15. The method according to claim 13, in which a long distance communication is divided into several transmission-reception messages and in which, between two successive messages, said microcontroller checks that said reader is not transmitting any query signals in RF-ID mode.

16. The method according to claim 11, in which, at the end of each communication with said reader, the RF device is no longer electrically powered apart from a clock.

17. A device for radiofrequency (RF) communication with a reader, the device being able to communicate at least over a short distance and over a medium distance and comprising an antenna and an RF-ID transponder connected to said antenna, the device also including a programmed microcontroller, a transceiver connected to said microcontroller and an electrical power source, the short distance communication being carried out using said antenna and said RF-ID transponder said RF-ID transponder being arranged to detect a command signal sent by said reader, and to connect at least said microcontroller to said power supply source when said command signal is detected, so that the medium distance communication can take place via said microcontroller and said transceiver.

18. The device according to claim 17, the device including a switch coupled to, on the one hand, said antenna and, on the other hand, to said transceiver and to said RF-ID transponder, said switch being able to take two positions, a short distance communication position for which the antenna is coupled to said RF-ID transponder and a medium or long range communication position for which the antenna is coupled to the transceiver.

19. The device according to claim 17, the device including a frequency selective coupler capable of connecting simultaneously the antenna to the RF-ID transponder and to the transceiver, in two separate frequency ranges.

20. The device according to claim 17, the device including at least one sensor connected to said microcontroller.
